(19) United States
(12) Patent Application Publication
(10) Pub. No.: US 2001/0024523 A1
(43) Pub. Date: Sep. 27, 2001

(54) Reduction of artifacts in a DWT-based compression scheme by adjusting inverse quantized transform data according to noise values

(76) Inventors: Yap-Peng Tan, Chandler, AZ (US); Tinku Acharya, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/863,478

(22) Filed: May 22, 2001

Related U.S. Application Data
(62) Division of application No. 09/165,511, filed on Oct. 2, 1998.

(51) Int. Cl. G06K 9/36; G06K 9/46

(52) U.S. Cl. 382/232; 382/207

(57) ABSTRACT

A method of processing an image by generating transform data in response to performing at least one discrete wavelet transform based upon original image data, generating adjusted data by combining noise with the transform data, and generating compressed data representing the image by quantizing based upon the adjusted data.

### BACKGROUND INFORMATION

(1) Field of the Invention

This invention is generally related to image coding and more particularly to the use of the discrete wavelet transform (DWT) during compression and decompression of images.

(2) Description of the Related Art

Image compression is commonly used to reduce the storage requirements and increase the transmission speed of images by representing the images using a smaller set of data. Starting with original pixel data that captures a scene, high performance image compression algorithms often use the mathematical technique of the discrete wavelet transform (DWT) in combination with a quantization methodology to obtain a smaller set of compressed data representing the image. The inverse of these operations are performed sequentially, beginning with the compressed data, to obtain decompressed image data which should accurately represent the image. One of the problems, however, of using this DWT-based approach is the occurrence of ringing artifacts when displaying the image using the decompressed data. The ringing artifacts are similar to the double outlines often seen on a television having poor reception. The artifacts are particularly noticeable by the human eye in images of scenes having low brightness content around objects with sharp edges or low contrast regions. The artifacts become more pronounced when using stronger quantization to obtain a smaller set of compressed data. Although strong quantization yields more compact data, the displayed image following decompression of such data suffers. Therefore, a novel technique for reducing ringing artifacts after decompression of a DWT-based compressed image is desirable.

### SUMMARY

According to an embodiment of the invention, a method is disclosed wherein second data is generated in response to performing at least one discrete wavelet transform based upon first data representing an image, noise is combined with the second data to generate third data, and the third data is quantized into fourth data representing the image.

Other features and advantages of various embodiments of the invention will be more apparent by referring to the description and claims below.

### BRIEF DESCRIPTION OF THE DRAWINGS

FIG. 1 illustrates a flow diagram of compression and decompression according to an embodiment of the invention.

FIG. 2 shows a flow diagram of image coding according to another embodiment of the invention.

FIG. 3 depicts multiple DWTs being performed starting with original image data.

FIG. 4 shows an imaging system application as an embodiment of the invention.

### DETAILED DESCRIPTION

As briefly summarized above, the method according to an embodiment of the invention involves adding noise to transform data after performing a DWT and before inverse-transforming to obtain the decompressed image data. Experimental results of performing a compression and decompression according to such a sequence show that ringing artifacts that appear when displaying the decompressed image data are reduced as compared to using the same sequence but without adding noise to the transform data. Also, in certain embodiments of the invention, particularly those in which multiple DWTs are performed, the addition of noise to a relatively small portion of the transform data may permit speedy compression. Such versions may be particularly suitable for implementation in imaging devices having limited resources, such as the digital camera or low cost video cameras.

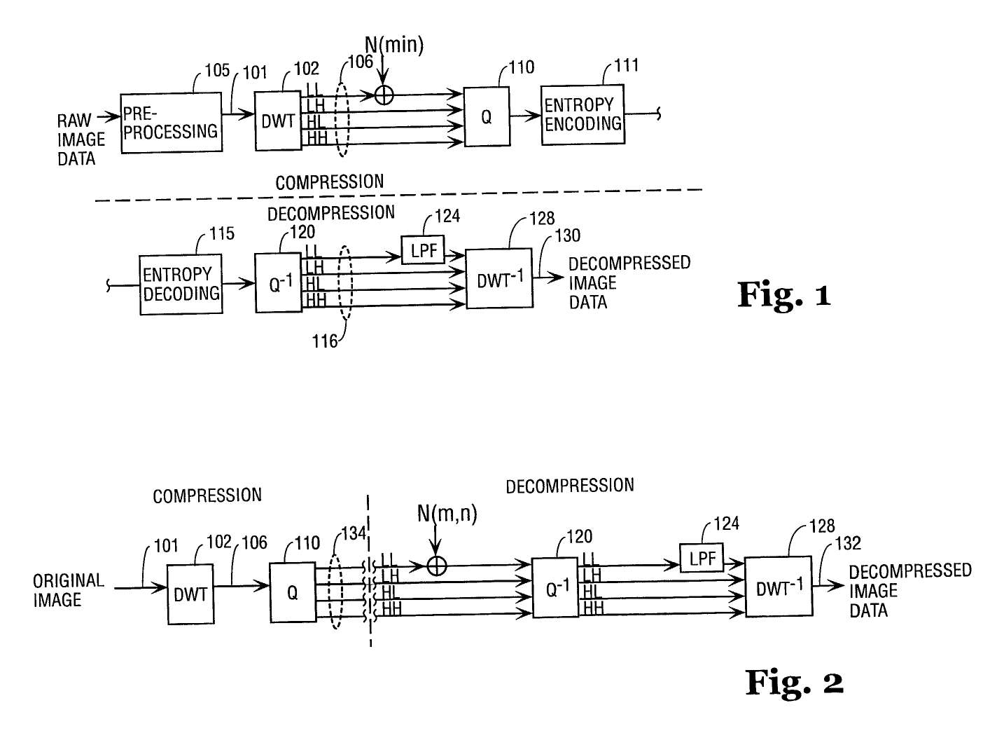

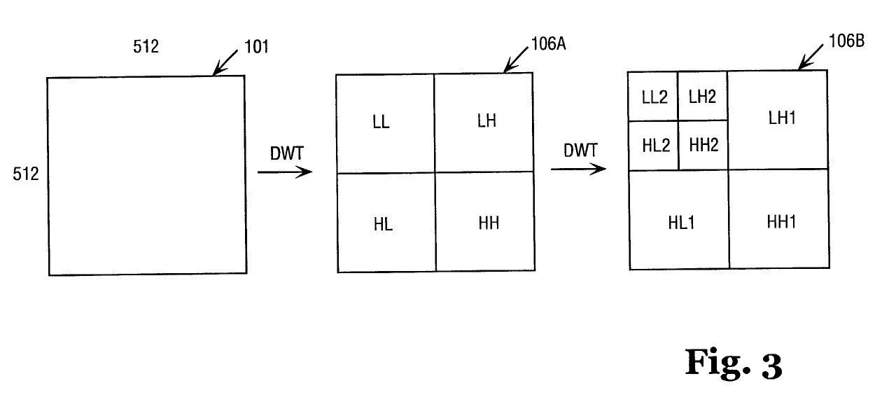

FIG. 1 illustrates an embodiment of the invention as a method of compression and decompression of original image data. The methodology of FIG. 1 begins with applying a DWT 102 to original image data 101 to obtain original transform data 106. The image data 101 may be a 512×512 array of pixels as shown in FIG. 3. The original image data 101 may be obtained using any conventional means, including the use of a digital camera having a solid-state image sensor. Some preprocessing 105 may optionally be performed upon raw image sensor data to obtain the original data 101. The pre-processing may feature the removal of fixed pattern sensor noise, color correction, tone adjustment, or other known processing steps.

Applying a single DWT 102 yields original transform data 106a that comprises wavelet coefficients in four groups called subbands LL, LH, HL, and HH (see FIG. 3). After performing the DWT 102, noise N_{ab}(m,n) is added to one or more selected ab subbands where in this example a single subband is selected, i.e., ab=LL. The noise adjusted subbands together with the remaining unadjusted ab subbands are then fed to a quantization block 110 which yields compressed data 114. The compressed data 114 represents the image but requires less storage space than the original image data 101, primarily due to the quantization 110. The quantization 110 is generally designed to reduce the so-called bit depth of each received data value. For instance, data values that are approximately zero are replaced by zero, thus allowing these values to be stored using less space.

Returning to FIG. 1, to achieve further compression, entropy encoding 111 is normally performed following the quantization 110 to yield encoded data 117. Entropy Encoding, e.g., Huffman encoding or run-length encoding, is designed to yield, on average, a shorter representation of the original image by using physically shorter code words for the more frequently occurring data values, and longer code words for the less likely occurring data values. The compressed data 114 or the encoded data 117 may then be transmitted or stored as needed by the imaging system application.

In order to recover the original image, the compressed data 114 is decompressed beginning with inverse quantization 120 to obtain decoded transform data 116. Of course, if entropy encoding 111 had been performed during the compression stage, then the encoded data 117 is subjected to entropy decoding 115 prior to being subjected to the inverse quantization 120. The inverse quantization 120 is normally the inverse of quantization 110 as known to those of ordinary skill in the art. Next, low pass filtering 124 may be applied to the adjusted subbands ab of the inverse quantized transform data 116. The addition of noise to the original transform data 106 may create the possibility of undesirable edge information in the adjusted transform data. Therefore, the low pass filtering 124 is designed to smooth such undesirable edges, towards ultimately making the decompressed image appear more pleasant to the human eye. The low pass filtering may be achieved by averaging the inverse quantized transform data 116 in local regions. The appropriate filtering for any given application can be readily developed by one of ordinary skill in the art in view of the amount of noise N_{ab}(m,n) that was added and the content of the original image.

After the adjusted subband has been subjected to the low pass filtering 124, the filtered transform data 119, having the same subband structure LL, LH, Hl, and HH as the original transform data 106, is subjected to an inverse DWT 128 to obtain decompressed data 130 representing the original image. The inverse DWT 128 corresponds to the inverse of the DWT 102 that was performed during compression. The details of the inverse DWT 128 are either well known or can be readily developed by one of ordinary skill in the art. It should be noted that the inverse DWT 128 does not by definition decompress. The use of “decompressed” to describe the data 130 is to clarify at a more practical level the result of the above-described sequence of mathematical steps.

The noise N_{ab} (m,n), where the m,n indices refer to the spatial location in the original transform data 106 and ab is the subband to be adjusted. As an example, the noise may have a gaussian probability density. If using the gaussian density, noise having a low variance (a) is preferred. If the variance is too large, then too much noise is introduced into the coding scheme, resulting in the decompressed image having an unacceptable quality. On the other hand, the variance should not be so low as to have little effect on the ringing artifacts that might otherwise appear if no noise were added to the coding scheme. Another possible noise function is one having a uniform density.

In general, the range of noise values should be adjusted so that the decompressed images have acceptable quality. If the magnitudes of the wavelet coefficients in the selected subbands of the original transform data 106 are relatively large, then the noise values may be proportionally larger, without degrading the quality of the decompressed image. Also, the variance of the noise may scale with the magnitudes of the wavelet coefficients in the selected subband.

The noise N_{ab} (m,n) may be combined with the original transform data 106 in one of several ways. For instance, a noise value randomly selected from a group of values may be added to each wavelet coefficient at location m,n in the ab subband. The group of values may be pre-determined by the particular probability density function selected. The same group of values may be used for a number of images. Alternatively, the noise values may be adapted to each original image based on the content of the image. Other ways of determining and adding the noise values to the transform data may be readily developed by those of ordinary skill in the art.

Another issue to consider when selecting the particular technique for combining noise with transform data is the computation required for determining the noise values and/or the space required for their storage. The additional computation and/or storage required for computing the nose values and adding the values to the original transform data 106 is to be balanced against the improvement obtained in the decompressed image. This issue may be particularly important when the compression stage of FIG. 1 occurs in an imaging device having limited resources, such as a portable digital camera.

FIG. 2 illustrates another embodiment of the invention as a coding scheme involving the addition of noise to transform data. In this embodiment, the compression and decompression sequences may be the same as in the embodiment of FIG. 1 except that the noise N_{ab} (m,n) is added after the inverse quantization 120 rather than before. The noise N_{ab} (m,n) is thus added during the decompression stage rather than during compression. Decompression may begin with inverse quantization 120, followed by the addition of noise N_{ab} (m,n) to the selected ab subbands, followed by low pass filtering 124 of the ab subbands, and finally the inverse DWT 128 to obtain decompressed data 132. Just as in the embodiment of FIG. 1, additional compression using, for instance, entropy encoding 111 following quantization 110, may be performed. Any corresponding entropy decoding is performed prior to the step of inverse quantization 120 in the decompression stage.

FIG. 3 presents several alternatives to the embodiments of the invention in FIGS. 1 and 2 described above. In FIGS. 1 and 2, the DWT 102 was applied only once to the original image data 101 to decompose the image into four subbands, one low frequency LL subband and three other frequency subbands referred to as LH, HL, and HH. This first level of decomposition is indicated by the transform data 106a in the sequence of FIG. 3. As shown in FIG. 3, however, the DWT 102 may be applied several times in succession in order to obtain successively smaller ab subbands to which the noise N_{ab} (m,n) may be added. Thus, the transform data 106 referred to in FIGS. 1 and 2 may be any one of the transform data 106a, 106b, or perhaps 106c, depending on the number of times the DWT 102 is applied in succession.

Regardless of the number of times the DWT 102 is applied in the compression stage, only the selected subbands ab are combined with the N_{ab} (m,n) and the low pass filtering 124. As the successive subbands are smaller, there are fewer noise and low pass filtering operations to be performed. This may yield faster compression, provided the increase in computation and storage resources for the additional DWTs do not offset the decrease obtained due to the smaller subbands. Note that whenever more than one DWT 102 is applied in the compression stage, then a corresponding a number of inverse DWTs 128 are applied in the decompression stage so that the decompressed data properly represents the original image.

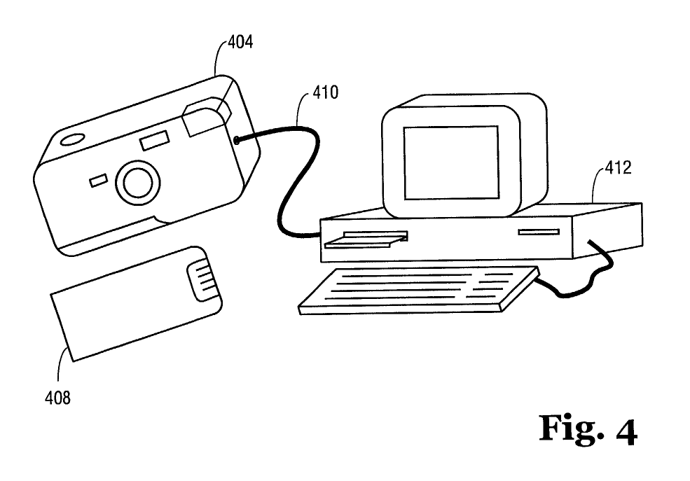

FIG. 4 shows a system application of the compression and decompression stages described above, according to another embodiment of the invention. In this embodiment, the compression may be implemented using a programmed processor with instructions aboard a semiconductor read only memory (ROM), or as dedicated logic circuitry, or as a combination of the two, aboard an imaging device such as a digital camera 404. The transform data obtained after the quantization 110 may be stored in a removable storage device 408 such as a non-volatile memory card and then transferred to a processing system 412. Alternatively, the compressed data may be transferred to the processing system 412 via any type of computer peripheral interface bus 410.

The decompression stages described above in FIGS. 1 and 2 are normally implemented in the processing system 412 which in one embodiment may be a personal computer (PC). The decompression stage in that embodiment would be implemented using processor instructions that may be stored in various types of machine readable media such as a semiconductor memory, magnetic disk, or CD ROM. Other imaging devices and processing systems, either in combination or as stand alone systems, may be used to implement the compression and decompression stages described above.

To summarize, various embodiments of the invention have been described above as methods of compressing and decompressing an image involving the addition of noise to DWT transform data to help reduce the occurrence of ringing artifacts in the decompressed image. The embodiments described above are, of course, subject to other variations in structure and implementation apparent to those of ordinary skill in the art. For instance, although the mathematical steps described above are normally performed directly upon the different data sets identified, it may be that scaling, offset corrections, or other operations that do not fundamentally affect the nature of the data sets are also performed prior to the mathematical steps. Also, the embodiments described may be adapted to process digital still images and digital video in a wide range of applications, including digital photography kiosks, video conferencing over a computer network, and in general any other applications that need compressed image data. It is intended that all such modifications and variations falling within the spirit and scope of the invention be covered by the appended claims.

1. A method of processing an original image, comprising:
generating second data in response to performing at least one discrete wavelet transform (DWT) based upon first data representing the image;
generating third data by combining noise with the second data; and
generating fourth data representing the image by performing a quantization based upon the third data.

2. The method of claim 1 wherein the second data comprises a plurality of subbands and the step of generating third data comprises adding noise to a selected one or more of said subbands.

3. The method of claim 1 further comprising:
generating fifth data in response to entropy encoding based upon the fourth data.

4. The method of claim 1 wherein the noise has a uniform probability density.

5. The method of claim 1 wherein the noise depends upon the content of the original image.

6. The method of claim 1 further comprising:
inverse quantizing based upon the fourth data to generate fifth data;
filtering based upon the fifth data to generate sixth data; and
inverse transforming based upon the sixth data.

7. The method of claim 2 further comprising
inverse quantizing based upon the fourth data to generate fifth data;
filtering based upon the fifth data to generate sixth data; and
inverse transforming based upon the sixth data, wherein the step of filtering comprises low pass filtering a portion of the fifth data corresponding to the selected subband.

8. The method of claim 1 wherein the step of generating second data comprises performing more than one DWT to obtain the second data, each additional DWT being performed upon transform data of a previous DWT.

9. The method of claim 8 further comprising:
inverse quantizing based upon the fourth data to generate fifth data;
filtering based upon the fifth data to generate sixth data; and
inverse transforming based upon the sixth data by performing a number of inverse DWTs that correspond to the DWTs in the step of generating the second data.

10. The method of claim 9 wherein the second data comprises subbands LL2, LH2, HL2, HH2, LH1, HL1, and HH1, and the step of generating third data comprises adding noise to the subband LL2,
and the step of filtering comprises low pass filtering a portion of the fifth data corresponding to the subband LL2.

11. A method comprising:
adjusting inverse quantized image transform data in accordance with noise values to obtain adjusted image data, said inverse quantized data obtained in response to quantization and inverse quantization methodologies performed based upon first transform data, said first transform data obtained in response to at least one discrete wavelet transform performed based upon original image data.

12. The method of claim 11 further comprising
generating second data in response to applying an inverse transformation methodology based on the adjusted data.

13. The method of claim 12 further comprising
applying an encoding method based upon the first transform data prior to applying said inverse quantization.

14. The method of claim 12 further comprising
filtering the adjusted data prior to applying said inverse transformation.

15. An article comprising:
a machine-readable medium having instructions which, when executed by a processor, cause
adding noise to second image transform data to obtain adjusted data, said second data obtained in response to a quantization methodology performed based on first image transform data, said first data obtained in response to at least one discrete wavelet transform performed based upon original image data.

16. The article of claim 15 wherein the machine-readable medium further comprises instructions which, when executed by the processor, further cause
inverse quantizing based upon the first data to obtain the second data; and
inverse transforming based upon the adjusted data.

17. The article of claim 16 wherein the machine-readable medium further comprises instructions which, when executed by the processor, further cause
filtering based upon the adjusted data prior to inverse transforming.

18. The article of claim 15 wherein the machine-readable medium further comprises instructions which, when executed by the processor, further cause
performing a decoding methodology to obtain the second data prior to adding noise.
